(19) United States
(12) Patent Application Publication
(10) Pub. No.: US 2009/0021636 A1
(43) Pub. Date: Jan. 22, 2009

(54) IMAGE PICKUP MODULE

(75) Inventors: SHU-JEN TSAI, Tu-Cheng (TW); LONG-FONG CHEN, Tu-Cheng (TW); WEN-HAW TSENG, Tu-Cheng (TW); SHIH-FANG WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/170,411

(22) Filed: Jul. 9, 2008

(30) Foreign Application Priority Data
Jul. 16, 2007 (CN) 200710201079.4

(51) Int. Cl. H04N 5/225

(52) U.S. Cl. 348/374; 348/E05.024

(57) ABSTRACT

An image pickup module is provided. The image pickup module includes a lens, a circuit board, an image sensor, a hollow base, and a lens seat. The image sensor is coupled to the circuit board and includes a housing package portion with a side periphery. The hollow base is disposed on the image sensor. The hollow lens seat is used for housing the lens and is disposed on the hollow base. The hollow lens seat is positioned according to the side periphery of the housing package portion.

### BACKGROUND

1. Technical Field

The present invention relates generally to an image pickup module.

2. General Background

CCD or CMOS Image sensors have been widely used in various areas and for devices including information terminals, such as a monitor camera. FIG. 6 shows a conventional image pickup module 10. In the illustrated image pickup module 10, an image sensor 12 is disposed on a circuit board 11. A lens seat 13 with a lens 14 is disposed on the circuit board 11 and secured to the circuit board 11 by two screws.

With such a structure, it is difficult to achieve adequate accuracy for the positional relation of the lens 14 to the image sensor 12, as illustrated in FIGS. 7 and 8, which show that the axis of the lens 14 is projected seriously deviated from the center of the image sensor 12. Therefore, devices with such image pickup module 10 may have imaging problems, such as image deflection and distortion.

Therefore, there is a need to provide an image pickup module which can solve the problems mentioned above.

### SUMMARY

The invention relates to an image pickup module. The image pickup module includes a lens, a circuit board, an image sensor, a hollow base, and a lens seat. The image sensor is coupled to the circuit board and includes a housing package portion with a side periphery. The hollow base is disposed on the image sensor. The lens seat is used for housing the lens and is disposed on the hollow base. The lens seat is positioned according to the side periphery of the housing package portion.

Other features and advantages will be or become apparent to one with skill in the art upon examination of the accompanying drawings and detailed description. It is intended that all such additional features and advantages be included within this description, be within the scope of the present invention, and be protected by the accompanying claims.

### BRIEF DESCRIPTION OF THE DRAWINGS

FIG. 1 is a sectional view of an image pickup module in accordance with one embodiment of the present invention.

FIG. 2 is an isometric view of a circuit board and an image sensor of the image pickup module of FIG. 1.

FIG. 3 is an isometric view of a hollow base of the image pickup module of FIG. 1.

FIG. 4 is a sectional view of the hollow base of FIG. 3, taken along the line VII-VII.

FIG. 5 is an isometric view of a lens seat of the image pickup module of FIG. 1.

FIG. 6 is an isometric, exploded view of a conventional image pickup module.

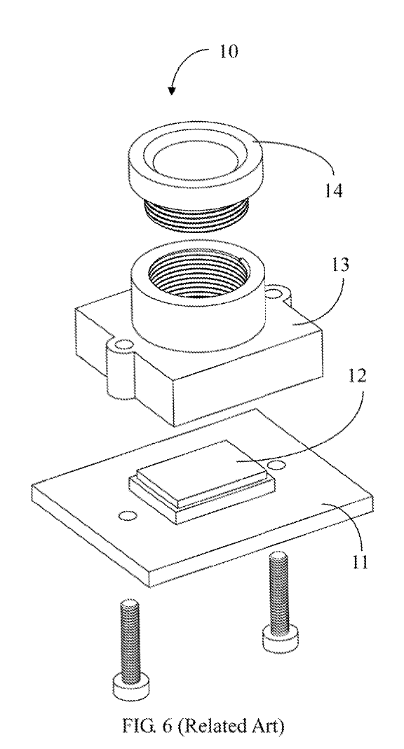

FIG. 7 is a sectional view of the image pickup module of FIG. 6 which shows a displacement of an axis of a lens of the image pickup module.

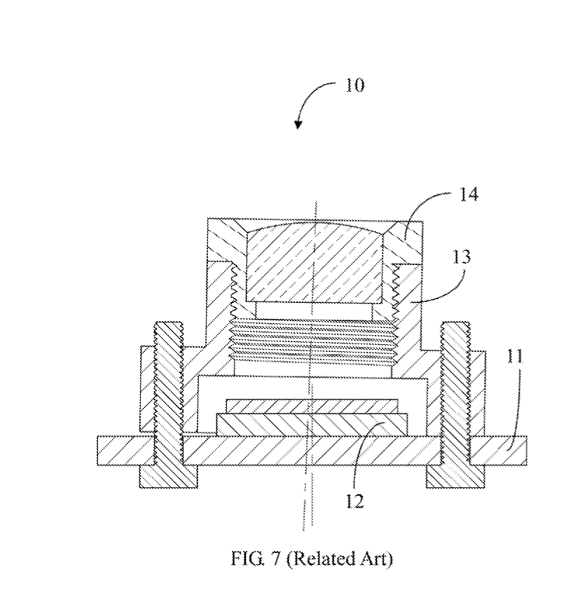

FIG. 8 is another sectional view of the image pickup module of FIG. 6 which shows a deflection of an axis of a lens of the image pickup module.

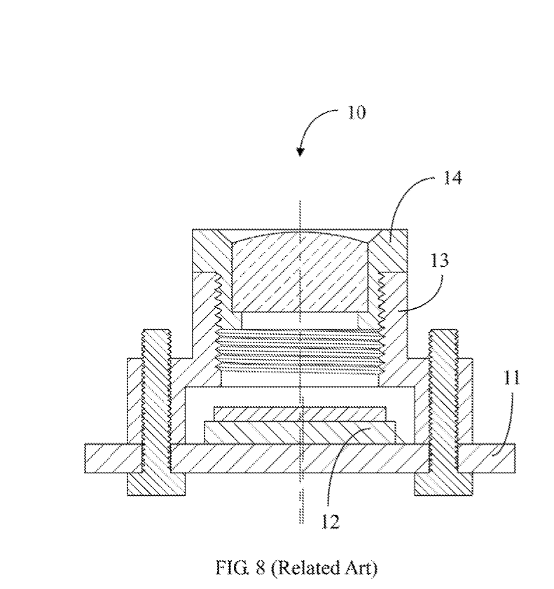

### DETAILED DESCRIPTION OF THE EMBODIMENTS

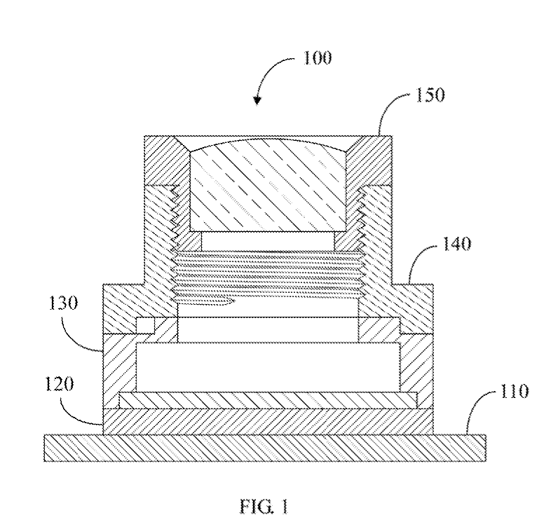

FIG. 1 shows an image pickup module 100 in accordance with one embodiment of the present invention. The image pickup module 100 includes a circuit board 110, an image sensor 120, a hollow base 130, a lens seat 140, and a lens 150.

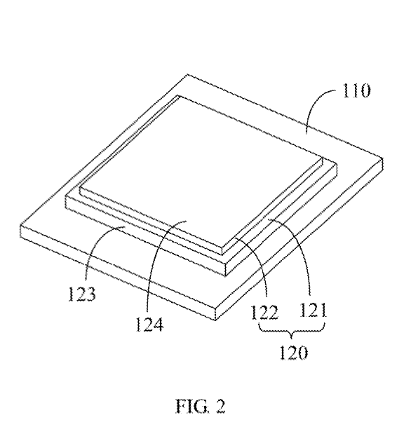

Referring to FIG. 2, the image sensor 120 is coupled to the circuit board 110. In the embodiment, the image sensor 120 includes a package portion 121 and a sealing glass sheet 122. The package portion 121 is of a rectangle shape and includes a side periphery 123 formed by four planar surfaces. The sealing glass sheet 122 is disposed on the package portion 121 and includes a top surface 124. The size of the sealing glass sheet 122 is slightly smaller than that of the package portion 121.

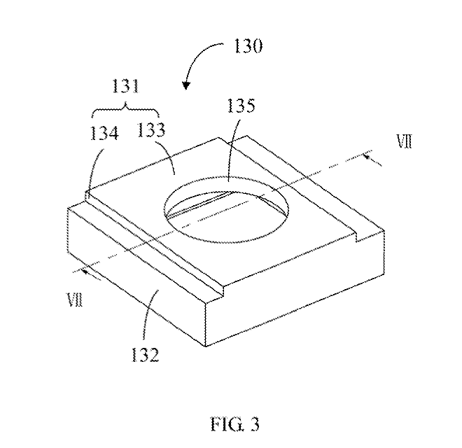

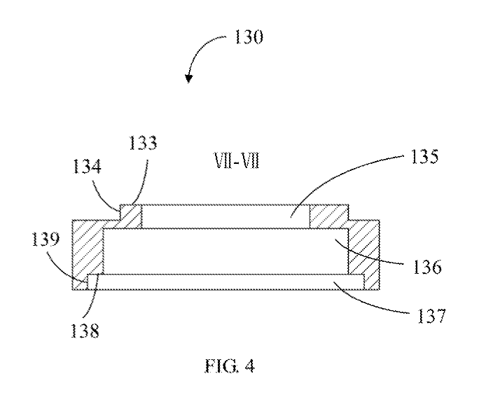

Referring to FIGS. 3 and 4, the hollow base 130 includes an upper portion 131 and a lower portion 132. The upper portion 131 protrudes from the top surface of the lower portion 132 and extends the full length of the lower portion 132. The upper portion 131 has a smaller width than the lower portion 132, dividing the top surface of the lower portion 132 into two parts. The upper portion 131 includes a top surface 133 and a side surface 134.

The hollow base 130 also includes an upper round hole 135 at the upper end, a middle opening 136, and a lower recess portion 137 at the lower end, which communicate with each other. The recess portion 137 is slightly larger in size than the middle opening 136, thereby forming a small step surface 138. The recess portion 137 includes a side periphery 139 and the side periphery 139 is slightly larger in size than the sealing glass sheet 122.

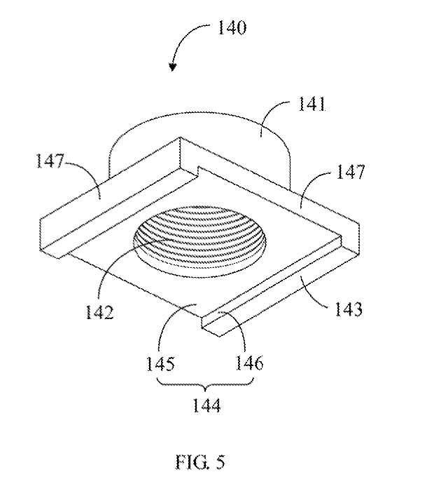

Referring to FIG. 5, the lens seat 140 includes an cylinder portion 141 having a threaded lens receiving hole 142 for receiving the lens 150. The lens seat 140 also includes a bottom portion 143 below the cylinder portion 141. The bottom portion 143 includes a recess portion 144 at the bottom end. The recess portion 144 communicates with the lens receiving hole 142 and includes a top surface 145 and a side surface 146.

In the embodiment, the top surface 145 is perpendicular to the side surface 146 and is also perpendicular to the central axis of the lens receiving hole 142. The bottom portion 143 further includes a side periphery 147, which is formed by four planar surfaces (two not shown). In one embodiment, the side periphery 147 has the same size as the side periphery 123 of the package portion 121.

In the embodiment, when constructing the image pickup module 100, the hollow base 130 is adhered to the image sensor 120. More specifically, the step surface 138 of the hollow base 130 is mated with the top surface 124 of the sealing glass sheet 122 and the sealing glass sheet 122 is enclosed and sealed in the recess portion 137 of the hollow base 130.

The lens seat 140 is adhered to the hollow base 130. More specifically, the top surface 145 of the recess portion 144 of the lens seat 140 is mated with the top surface 133 of the hollow base 130. The side surface 146 of the lens seat 140 can be mated with the side surface 134 of the hollow base 130, thus the lens seat 140 can be guided to move along the side surface 134 or in a direction perpendicular to the side surface 134 until the lens 140 is positioned.

When positioning the lens seat 140, the side periphery 123 of the package portion 121 is used as a reference plane and an auxiliary locating device (not shown) is used to locate the lens seat 140 in a position where the side periphery 147 of the lens seat 140 is aligned with the side periphery 123.

The surfaces and dimensions of the image sensor 120 have been manufactured and packaged with very high precision. That is, the top surface 124 of the sealing glass sheet 122 and the side periphery 123 of the package portion 121 have a very tight tolerance of dimension and geometric form. The hollow base 130, the lens seat 140 and the lens 150 are also constructed with high precision. Therefore, after being assembled, the axis of the lens 150 is projected to the center of the image sensor 120 with high precision.

Since the image pickup module 100 is designed and made in the structure of the lens seat 140 attaching to the hollow base 130, if there still exists some problems rendering that the axis of the lens 150 does not project onto the center of the image sensor 120 with sufficient precision, the lens seat 140 can be replaced with a new one to fix such problems.

What is claimed is:

1. An image pickup module comprising:
a lens;
a circuit board;
an image sensor, coupled to the circuit board, including a housing package portion having a side periphery;
a hollow base disposed on the image sensor; and
a hollow lens seat, for housing the lens, disposed on the hollow base and positioned according to the side periphery of the housing package portion.

2. The image pickup module according to claim 1, wherein the hollow base includes a recess portion with a side edge for guiding the hollow lens seat.

3. The image pickup module according to claim 1, wherein the image sensor includes a sealing glass sheet disposed on the package portion, the hollow base is disposed on the sealing glass sheet.

4. An image pickup module comprising:
a lens;
a circuit board;
an image sensor, coupled to the circuit board, including a housing package portion having a side periphery;
a hollow base disposed on the image sensor, the hollow base defining a hole for the lens to form an image on the sensor; and
a hollow lens seat, for housing the lens, disposed on the hollow base and positioned according to the side periphery of the housing package portion.

5. The image pickup module according to claim 4, wherein the hollow base includes a recess portion with a side edge for guiding the hollow lens seat.

6. The image pickup module according to claim 4, wherein the image sensor includes a sealing glass sheet disposed on the package portion, the hollow base is disposed on the sealing glass sheet.
